(19) United States
(12) Patent Application Publication
(10) Pub. No.: US 2026/0369206 A1
(43) Pub. Date: Nov. 19, 2026

(54) REGIONAL ANTI-AGING MONITORING FOR ORGANIC LIGHT-EMITTING DIODE

(71) Applicant: QUALCOMM Incorporated, San Diego, CA (US)

(72) Inventors: Nan ZHANG, Beijing (CN); Xinchao YANG, Shanghai (CN); Qi ZENG, Shenzhen (CN)

(21) Appl. No.: 19/487,659

(22) PCT Filed: Jun. 9, 2023
(86) PCT No.: PCT/CN2023/099357

§ 371 Date: Nov. 25, 2025

(51) Int. Cl. G09G 3/20; G09G 3/00; G09G 3/3233

(52) U.S. Cl. CPC G09G 3/2074; G09G 3/035; G09G 3/3233; G09G 2320/0233; G09G 2320/0242; G09G 2320/029; G09G 2320/046; G09G 2320/048; G09G 2320/0686; G09G 2320/0693; G09G 2330/10; G09G 2354/00; G09G 2360/144

(57) ABSTRACT

Disclosed is a computing device (100a, 100B,200,300,500) configured to control a display (120a,512) that includes a region-of-interest (ROI) (130a, 140b) and at least one other region separate from the ROI (130a, 140b). Various aspects may include recording first information regarding illumination of pixels within the ROI (130a,140b) using a first spatial-temporal sample strategy (402), recording second information regarding illumination of pixels within the at least one other region using a second spatial-temporal sample strategy, wherein the first spatial-temporal sample strategy records more information per pixel than the second spatial-temporal sample strategy over the same amount of time (404). An output of the display (120a,512) in the ROI (130a, 140b) may be modified based on an analysis of the recorded first information (406).

### BACKGROUND

Computing devices equipped with organic light-emitting diode (OLED) displays are susceptible to a condition called burn-in. Burn-in refers to the permanent damage that often occurs when a static image or pattern is displayed for extended periods on a screen forming the display. Burn-in is generally caused by the organic compounds in OLED pixels aging unevenly. The susceptibility to burn-in of different regions of a display may depend upon factors like screen usage patterns, brightness levels, and the duration of displaying static elements. A difference in appearance may be noticeable between the different regions of a display, particularly in brightly lit areas or in sunlight. This difference is unappealing and may distract from the display function of the device, potentially interfering with the overall function of the computing device.

Manufacturers have implemented various technologies and strategies to mitigate burn-in risks, including pixel shifting, screen savers, and algorithms that reduce static image persistence. Additionally, user awareness and responsible usage can help minimize the chances of burn-in, such as avoiding prolonged display of static elements or adjusting screen brightness levels. However, these mitigation techniques do not differentiate between regions of a display.

### SUMMARY

Various aspects include methods and computing device configured to perform the methods for modify an output of a display that includes a region-of-interest (ROI) and at least one other region separate from the ROI. Various aspects may include recording first information regarding illumination of pixels within the ROI using a first spatial-temporal sample strategy and recording second information regarding illumination of pixels within the at least one other region using a second spatial-temporal sample strategy, in which the first spatial-temporal sample strategy records more information per pixel than the second spatial-temporal sample strategy over the same amount of time, and modifying an output of the display in the ROI based on an analysis of the recorded first information.

In some aspects, the first spatial-temporal sample strategy may include a first number of pixels per sample and the second spatial-temporal sample strategy includes a second number of pixels per sample, in which the first number of pixels per sample is less than the second number of pixels per sample. In some aspects the ROI may correspond to a region of the display including at least one of a dynamic island or a folding region of a foldable display. In some aspects the ROI may correspond to a region of the display other than a dynamic island or folding region of a foldable display. In some aspects the recording the first information regarding illumination of pixels within the ROI may include recording the first information at a per-pixel level within the ROI. In some aspects recording the first information regarding illumination of pixels within the ROI may include recording the first information at a sub-pixel level within the ROI. In some aspects recording the second information regarding illumination of pixels within the at least one other region may include recording pixel illumination information reflective of groups of pixels within the at least one other region.

Some aspects may further include identifying pixels of the display meeting a threshold characteristic and including within the ROI the identified pixels meeting the threshold characteristic. In some aspects, the threshold characteristic may include an accumulated on-time greater than a temporal threshold. Some aspects may further include detecting pixels subject to a sustained level of physical strain, and including within the ROI the detected pixels subject to the sustained level of physical strain.

Further aspects may include a computing device having a processor configured to perform one or more operations of any of the methods summarized above. Further aspects may include a non-transitory processor-readable storage medium having stored thereon processor-executable instructions configured to cause a processor of a computing device to perform operations of any of the methods summarized above. Further aspects include a computing device having means for performing functions of any of the methods summarized above.

Further aspects include a system on chip for use in a computing device that includes a processor configured to perform one or more operations of any of the methods summarized above.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIGS. 1A-1B illustrates an example computing device with a display having an ROI including a dynamic island suitable for implementing various embodiments.

FIGS. 1C-1D illustrate an example computing device displaying an ROI including folding regions of a foldable display suitable for implementing any of the various embodiments.

FIG. 2 is a component block diagram illustrating an example computing system suitable for implementing various embodiments.

FIG. 3 is a functional block diagram of an example computing device suitable for implementing various embodiments.

FIG. 4A is a process flow diagram illustrating a method that may be performed by a processor of a computing device for modifying an output of an ROI of the display according to various embodiments.

FIGS. 4B-4C are process flow diagrams illustrating operations that may be performed by a processor of a computing device as part of the method for modifying an output of an ROI of the display according to various embodiments.

FIG. 5 is a component block diagram of a computing device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and embodiments are for illustrative purposes and are not intended to limit the scope of the claims.

Various embodiments include systems and methods for controlling a computing device display by modifying an output of a region-of-interest (ROI) of the display differently than at least one other region of the display based on an analysis of recorded information regarding illumination of pixels within the ROI. Various embodiments may improve the operation of a computing device by improving the operation of the display of the computing device, in particular computing devices having at least one of a dynamic island or a hinge region of a foldable display.

In various embodiments, a computing device may record first information regarding illumination of pixels within the ROI using a first spatial-temporal sample strategy. In addition, the computing device may record second information regarding illumination of pixels within the at least one other region using a second spatial-temporal sample strategy. The first spatial-temporal sample strategy may record more information per pixel than the second spatial-temporal sample strategy over the same amount of time. The computing device may then modify the output of the display in the ROI based on an analysis of the recorded first information.

The term “computing device” is used herein to refer to any one or all of cellular telephones, smartphones, portable computing devices, personal or mobile multi-media players, laptop computers, tablet computers, smartbooks, ultrabooks, palmtop computers, wireless electronic mail receivers, multimedia Internet-enabled cellular telephones, medical devices and equipment, biometric sensors/devices, wearable devices including smart watches, smart clothing, smart glasses, smart wrist bands, smart jewelry (e.g., smart rings, smart bracelets, etc.), entertainment devices (e.g., gaming controllers, music and video players, satellite radios, etc.), wireless-network enabled Internet of Things (IoT) devices including smart meters/sensors, router devices, industrial manufacturing equipment, large and small machinery and appliances for home or enterprise use, computing devices affixed to or incorporated into various mobile platforms, global positioning system devices, and similar electronic devices that include a memory, wireless communication components and a programmable processor.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. An SIP may also include multiple independent SOCs coupled together via high speed communication circuitry and packaged in close proximity, such as on a single motherboard or in a single wireless device. The proximity of the SOCs facilitates high speed communications and the sharing of memory and resources.

As used herein, the terms “network,” “system,” “wireless network,” “cellular network,” and “wireless communication network” may interchangeably refer to a portion or all of a wireless network of a carrier associated with a wireless device and/or subscription on a wireless device. The techniques described herein may be used for various wireless communication networks, such as Code Division Multiple Access (CDMA), time division multiple access (TDMA), FDMA, orthogonal FDMA (OFDMA), single carrier FDMA (SC-FDMA) and other networks. In general, any number of wireless networks may be deployed in a given geographic area. Each wireless network may support at least one radio access technology, which may operate on one or more frequency or range of frequencies. For example, a CDMA network may implement Universal Terrestrial Radio Access (UTRA) (including Wideband Code Division Multiple Access (WCDMA) standards), CDMA2000 (including IS-2000, IS-95 and/or IS-856 standards), etc. In another example, a TDMA network may implement GSM Enhanced Data rates for GSM Evolution (EDGE). In another example, an OFDMA network may implement Evolved UTRA (E-UTRA) (including LTE standards), Institute of Electrical and Electronics Engineers (IEEE) 802.11 (Wi-Fi), IEEE 802.16 (WiMAX), IEEE 802.20, Flash-OFDM®, etc. Reference may be made to wireless networks that use LTE standards, and therefore the terms “Evolved Universal Terrestrial Radio Access,” “E-UTRAN” and “eNodeB” may also be used interchangeably herein to refer to a wireless network. However, such references are provided merely as examples, and are not intended to exclude wireless networks that use other communication standards. For example, while various Third Generation (3G) systems, Fourth Generation (4G) systems, and Fifth Generation (5G) systems are discussed herein, those systems are referenced merely as examples and future generation systems (e.g., sixth generation (6G) or higher systems) may be substituted in various embodiments.

Some computing devices use some regions on a display screen (i.e., referred to herein as just a “display”) differently than others, which may lead to one region of the display aging faster than others. For example, many computing devices include a portion of the display in which one or more cameras and other sensors, such facial recognition system sensors, or proximity sensors, are located. The region containing such sensors incorporated into a display is often referred to as a “display cut out.” More recently, some computing devices have implemented a graphical mask region immediately adjacent to and surrounding the display cut outs. The graphical mask region may mimic the appearance of the display cut outs, which are generally dark, to give the appearance of a larger symmetrical region that is more aesthetic. The graphical mask region and the display cut outs together are often referred to as a display island. The region of the display corresponding to the display island, or at least the graphical mask region, is generally prone to aging faster than the main regions of the display.

Additionally, some computing devices have implemented display islands configured to change size or shape. Such a changeable display island is often referred to as a “dynamic island.” Dynamic islands often appear as a pill-shaped area at the top of the display that not only contains sensors but also serves as a shape-changing hub for key user alerts. The dynamic island may change shape and size to display alerts and notifications. To visually disguise the dynamic island or at least portions thereof, a processor of the computing device may control the display of the graphical mask region to appear either similar to any display cut outs (i.e., the same dark color) or similar to any display outside the dynamic island. In this way, the graphical mask region, when not used for alerts or notification, may mimic or present as an extension of the adjacent display. A drawback of dynamic islands, like the display island, is that some portions may require higher run-times, which promotes premature aging issues, like burn-in.

Further, in addition to regions of the display aging faster due to characteristics of the pixels output, other regions may age faster due to physical stresses unique to a region of the display. For example, some newer computing devices include foldable OLED displays, which allow the computing device to fold and take on a more compact form. Foldable OLED displays present additional challenges due to their flexible nature, such as potential stress on the display layers or hinges in the folding region. Such physical stresses on the folding region of foldable displays may result in premature aging issues, which may be visible in the output of the pixels in that region.

Conventional anti-aging solutions for computing devices with a display island, dynamic island, or a foldable display have not prevented those regions from premature aging, as compared to other portions of the display. For example, one technique that may be used as an anti-aging solution is full frame pixel recording, which periodically records all the information associated with every pixel on the OLED display. The information recorded may include pixel run-time, intensity, color, and other performance data variables associated with every pixel or sub-pixel on the full display. These periodic recordings of pixel information are stored and maintained as a pixel or sub-pixel history. Such information may be used to monitor and adjust pixel performance over time. The adjustments may be in response to detected variations in pixel performance in order to mitigate issues like non-uniform aging, brightness decay, and image retention. These techniques may help ensure accurate and uniform pixel performance to deliver a high-quality and visually appealing output.

However, full frame pixel recording for conventional computing devices with display islands, dynamic islands, or foldable displays do not optimize memory usage, power consumption, or other visual qualities of those regions. For example, conventional smartphones may use over 200 megabytes of memory to record a full frame pixel run-time usage history and consume relatively high power in doing so, particularly with 1 minute sampling intervals. In addition, even after analyzing the full frame pixel run-time usage history and expending the power to collect it, such systems may still lead to poor visual quality in regions that include a display island, dynamic island, and/or foldable display. In fact, recording of the full frame pixel run-time usage history is generally limited to a per pixel level due to memory constraints. Per physical sub-pixel recording would demand too high a data throughput, memory usage, and power cost. In this way, conventional full screen recording sample rates are limited to once or twice per minute to save power, even though a 1 minute sample rate demands a relatively high level of power consumption (e.g., 10 mA-20 mA). Nonetheless, a once per minute sample rate tends to be too slow to capture dynamic user interface changes, particularly for purposes of anti-aging techniques such as for dynamic islands or foldable displays. Significant amounts of pixel data may be missed in those portions of the display when video or other quickly changing display elements are presented.

Various embodiments include methods and computing devices configured to perform the methods for controlling a computing device display with one or more region-of-interest (ROI). Regions like the graphical mask used for display islands or dynamic islands, as well as the folding region of a foldable display, may be considered ROIs, which may be distinguished from one or more other region of the display. The methods may include recording first information regarding illumination of pixels within the ROI using a first spatial-temporal sample strategy and recording second information regarding illumination of pixels within the at least one other region of the display using a second spatial-temporal sample strategy. The first spatial-temporal sample strategy may record more information per pixel than the second spatial-temporal sample strategy over the same amount of time. For example, the first spatial-temporal sample strategy may include a first sample rate that is higher than a second sample rate of the second spatial-temporal sample strategy. Additionally or alternatively, the first spatial-temporal sample strategy may record information for smaller spatial groupings of pixels or sub-pixels than the second spatial-temporal sample strategy over the same amount of time (e.g., individual pixel samples versus 4×4 or 8×8 tiles of pixels). An output of the display in the ROI may be modified based on an analysis of the recorded first information. The modification of the display in the ROI may thus be different than more traditional anti-aging modifications applied to the at least one other region of the display.

As used herein, the expression “information regarding illumination of pixels” refers to values associated with individual pixels and/or sub-pixels that control the output thereof to achieve a desired image and/or image quality. In this way, the information regarding illumination of pixels (e.g., first information and/or second information) may include values for the supplied amount of electric current, the subpixel color intensities, the gray levels, the pixel refresh rate, and/or the pixel compensation. The precise control of these variables may be achieved through the driving circuitry and control algorithms implemented by the processor controlling the OLED display. The processor controlling the display may send signals to each pixel to adjust the desired parameters and create the final image. By manipulating these variables, OLED pixel output may be optimized using factors like brightness, contrast, color accuracy, and power efficiency, resulting in high-quality and visually appealing displays.

The electric current supplied to each OLED pixel determines the intensity of light emitted by that pixel. By adjusting (i.e., modifying) the current, the brightness of the pixel can be controlled. Higher current values result in brighter pixels, while lower values produce dimmer pixels. OLED pixels are composed of three subpixels: red (R), green (G), and blue (B). By varying the current flowing through each subpixel, the intensity of each color can be adjusted independently. This allows for precise control over the color balance and overall color output of the pixel. OLED pixels can produce a range of gray levels by adjusting the intensity of each subpixel. By controlling the current flowing through the subpixels, different combinations of red, green, and blue light can be emitted, resulting in various shades of gray. This capability enables smooth gradations and accurate rendering of grayscale images.

Additionally, the refresh rate of OLED pixels refers to how quickly the pixels can change their illumination state. A higher refresh rate allows for smoother motion and reduces motion blur in fast-paced content, such as videos or games. The refresh rate is typically controlled by the driving circuitry of the display.

OLED displays may experience non-uniform pixel aging, which can lead to variations in brightness and color over time. Pixel compensation techniques, such as algorithms and calibration routines, can be employed to mitigate these effects. These compensation methods help equalize the aging characteristics of individual pixels and maintain consistent image quality across the display.

As used herein, the expression “spatial-temporal sample strategy” refers to a methodology of systematically selecting samples or data points from both spatial and temporal dimensions. Spatial-temporal sample strategy considers the spatial location and temporal aspect of the data to ensure representative and meaningful sampling. The spatial dimension may define the physical size of individual samples within a set of samples, thus specifying how many pixels or sub-pixels are included in each sample within the set. For example, the spatial dimension of a spatial-temporal sample strategy may include one sub-pixel, one pixel, or a set number of pixels in each sample within each set of samples. In contrast, the temporal dimension may define the frequency in which samples are taken. For example, the temporal dimension of a spatial-temporal sample strategy may sample every second, every minute, or some other interval of time.

Various embodiments may improve the operation of a computing device by enabling the computing device to reduce anti-aging memory usage (e.g., from 200 MB to less than 20 MB). In accordance with various embodiments, the visual quality over time of dynamic islands and/or folding regions of foldable displays may be optimized or at least improved greatly. Various embodiments may minimize burn-in issues often associated with dynamic islands and/or foldable displays.

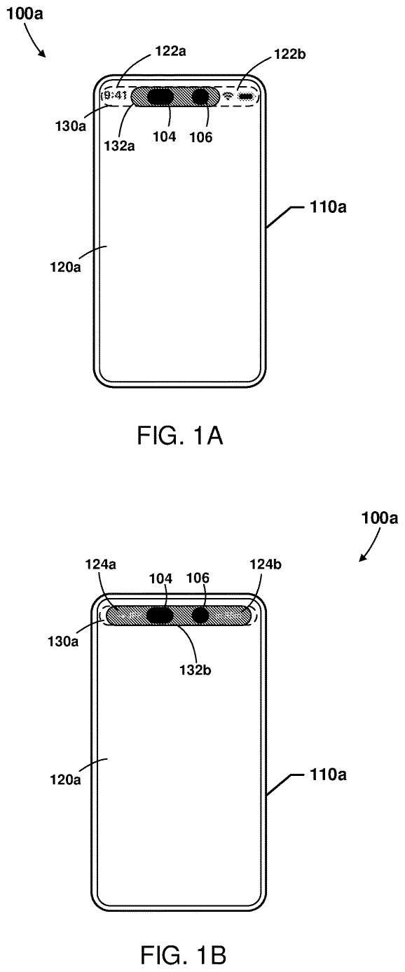

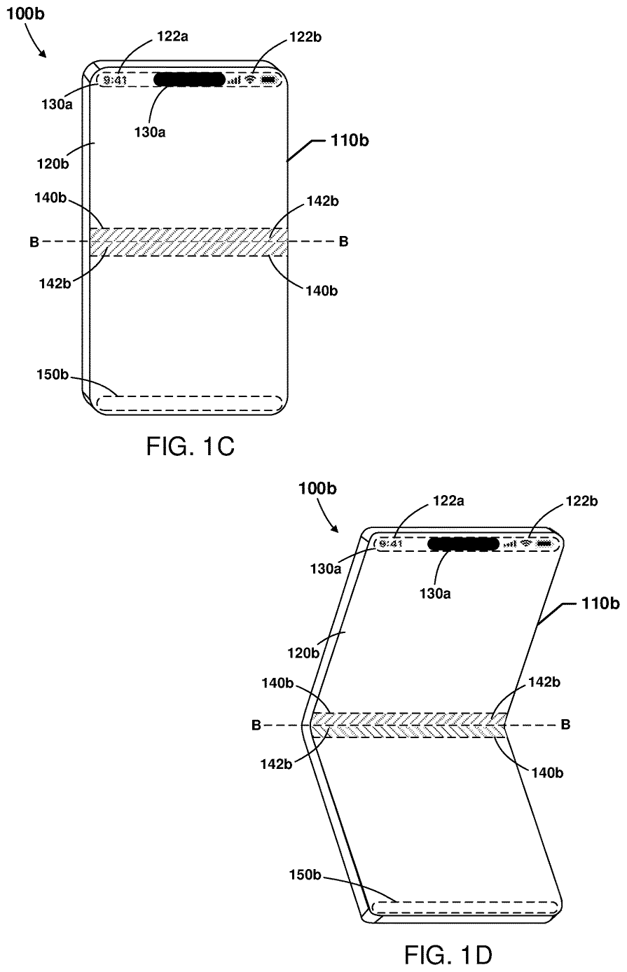

FIGS. 1A and 1B illustrate an example computing device 100a suitable for implementing any of the various embodiments. The computing device 100a may include a body 110a having at least one side with a display 120a. The display 120a may incorporate one or more display cut outs 104, 106. The display cut outs 104, 106 may be formed to accommodate the operation of one or more devices disposed behind the display 120a, such as a camera, an ambient light sensor, facial recognition system sensors, proximity sensors, and/or other suitable devices. Although two display cut outs 104, 106 are illustrated, the display may include only one cut out or greater than two cut outs. In addition, although display cut outs like the two display cut outs 104, 106 are typically located at the top center of the display 120a, the one or more display cut outs 104, 106 may be located almost anywhere on the display.

In accordance with various embodiments, the display 120a may include a designated region-of-interest (ROI) 130a. The ROI 130a may be assigned to a portion of the display 120a identified as needing special attention for potential signs of early pixel degradation, in contrast to other regions of the display 120a. In particular, the ROI 130a may correspond to a portion of the display 120a implemented as a display island and/or dynamic island, having a graphical mask region adjacent the one or more display cut outs 104, 106. In some embodiments, there may be more than one ROI, which may be remote from one another and/or contiguous with one another.

In FIG. 1A a small portion of the dynamic island is visible, displayed as a narrow pill-shaped region 132a at one end (e.g., the top) of the display 120a. The narrow pill-shaped region 132a flanks and/or surrounds the display cut outs 104, 106. As is typical for a dynamic island, the narrow pill-shaped region 132a need not encompass the entire ROI 130a. In this way, the portions of the ROI 130a outside the narrow pill-shaped region 132a may be configured to mimic the background and/or other graphics presented on the main part of the display 120a. In addition, the portions of the ROI 130a outside the narrow pill-shaped region 132a may include customary persistent indicators 122a, 122b, such as the time, wireless connection signal strength, battery power level, or the like.

In FIG. 1B a larger portion of the dynamic island is visible, displayed as a wider pill-shaped region 132b. The wider pill-shaped region 132b may also flank and/or surround the display cut outs 104, 106. However, in contrast to the narrow pill-shaped region 132a, the wider pill-shaped region 132b may encompass more of or even the entire ROI 130a. The wider pill-shaped region 132b may be configured to include customized indicators 124a, 124b specific to one or more applications running on the computing device 100a. For example, the customized indicators 124a, 124b may display notifications for a navigation App or the like.

A processor of the computing device 100a may control the display 120a, and particularly the pixels used for the dynamic island, to display the narrow pill-shaped region 132a, the wider pill-shaped region 132b, another shape. Alternatively, the graphical mask region of the dynamic island may entirely mimic the background and/or graphics presented on the main part of the display 120a, thus not distinguishable from the main part. The processor of the computing device 100a may configure the dynamic island or portions thereof with a color, or no color, similar to a color visible in the display cut outs 104, 106 or adjacent portions of the main display 120a.

In various embodiments, the display 120a may incorporate one or more touch sensor devices to form a touchscreen display. The touch sensor device(s) may be configured to detect a change in capacitance at a location where the sensor(s) is(are) touched (or nearly touched) by an object, particularly be a user's hand, thumb, or fingers.

FIGS. 1C and 1D illustrate another example computing device 100b suitable for implementing any of the various embodiments. The computing device 100b may include a foldable body 110b having at least one side with a foldable display 120b. The foldable display 120b may include many of the features and characteristics described above for the display (i.e., 120a) in FIGS. 1A and 1B.

Foldable displays, such as foldable display 120b, utilize a flexible screen technology that enables the foldable display 120b to bend or fold without causing damage or affecting its functionality. Typically, these displays employ OLEDs, where individual organic pixels emit light when an electric current is applied to them. To allow for flexibility, the foldable display 120b may incorporate a flexible substrate made of thin plastic or ultra-thin glass that can withstand repeated bending. The display consists of multiple layers, with the flexible substrate serving as the base and various layers, including the OLED layer, touch sensors, and protective layers, stacked on top. To support the foldable display 120b, the computing device 100b may also incorporate a durable hinge mechanism that facilitates the folding and unfolding of at least two folding regions 142b of the foldable display 120b, ensuring smooth movement without compromising the screen quality. In this way, two adjacent folding regions 142b may bend around an axis B-B, enabling the two separate portions of the foldable display 120b to fold over toward one another. The two adjacent folding regions 142b may extend from the fold axis B-B (e.g., vertically in the orientation shown in FIGS. 1C and 1D) some distance, reflecting the regions of the display that experience physical compression, expansion, and/or other strain from the folding or unfolding movement. The fold axis B-B may not be distinguishable from the rest of the foldable display 120b, bending elastically, rather than pivoting like a door hinge. Depending on the folding configuration, the foldable display 120b may offer different display modes, adapting content to the screen's orientation.

To provide a seamless user experience, software optimization may detect the folding state of the foldable display 120b and adjust the content accordingly.

In accordance with various embodiments, the two adjacent folding regions 142b of the foldable display 120b may be designated as an ROI 140b. Like the ROI 130a described above with regard to FIGS. 1A and 1B, the ROI 140b may need special attention for potential signs of early pixel degradation, in contrast to other regions of the display 120b. In some embodiments, there may be more than one ROI on the display, which may be remote from one another and/or contiguous with one another. For example, the ROI 130a corresponding to the dynamic island may be a first ROI 130a and the ROI 140b corresponding to the folding regions 142b may be a second ROI 140b. Alternatively, one or both of the first ROI 130a and the second ROI 140b may be divided into sub-ROIs. In this way, an ROI (e.g., first ROI 130a, second ROI 140b) may comprise more than one ROI.

In accordance with various embodiments, the display of the computing device (e.g., the display 120a and/or the foldable display 120b) may include another ROI 150b that does not correspond to a dynamic island, foldable region of a foldable display, or the like. The other ROI 150b may be a region of the display (e.g., the bottom edge of the foldable display 120b) known for being prone to premature aging. For example, the other ROI 150b may correspond to an area that regularly contacts an opposed portion of the foldable display 120b or an area that often engages a case or other element used in conjunction with the computing device 100b. As another example, the other ROI 150b may not be an area typically known to prematurely age but rather may be determined to be an area that prematurely ages after an analysis of recorded information regarding the illumination of pixels in that region.

In FIG. 1C the foldable display 120b is wide open in a planar configuration. The planar configuration may be used to present graphics on both the upper and lower sides of the foldable display 120b. In this way, in the planar configuration the foldable display 120b may be indistinguishable from a conventional non-foldable display. In FIG. 1D the foldable display 120b is partially folded with the two adjacent folding regions 142b bent toward one another.

A processor of the computing device 100b may control the display 120b, and particularly the pixels used for the folding regions 142b, to appear as a continuous extension of the graphics presented on the foldable display 120b. The processor of the computing device 100b may configure the folding regions 142b with a color, or no color, similar to a color visible on adjacent portions of the folding display 120b.

Like the display (e.g., display 120a) described above with regard to FIGS. 1A and 1B, the foldable display 120b may incorporate one or more touch sensor devices to form a touchscreen display. The touch sensor device(s) may be configured to detect a change in capacitance at a location where the sensor(s) is(are) touched (or nearly touched) by an object, particularly be a user's hand, thumb, or fingers.

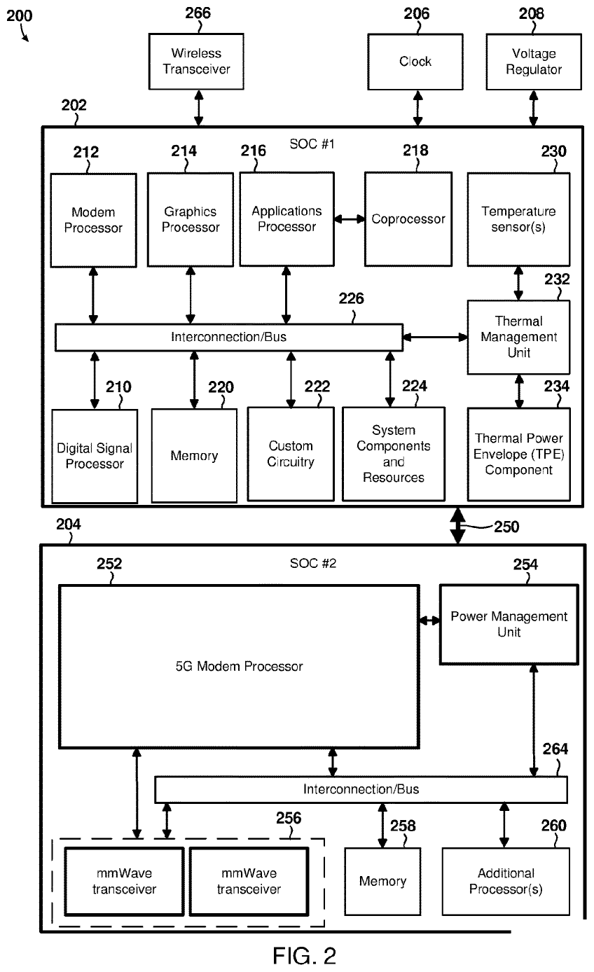

FIG. 2 is a component block diagram illustrating an example computing system 200 suitable for implementing any of the various embodiments. Various embodiments may be implemented on a number of single processor and multiprocessor computer systems, including a system-on-chip (SOC) or system in a package (SIP).

With reference to FIGS. 1A-2, the illustrated example computing system 200 (which may be a SIP in some embodiments) includes two SOCs 202, 204 coupled to a clock 206, a voltage regulator 208, and a wireless transceiver 266 configured to send and receive wireless communications via an antenna (not shown) to/from a wireless device (e.g., computing devices 100a, 100b) or a remote base station. In some embodiments, the first SOC 202 may operate as central processing unit (CPU) of the wireless device that carries out the instructions of software application programs by performing the arithmetic, logical, control and input/output (I/O) operations specified by the instructions. In some embodiments, the second SOC 204 may operate as a specialized processing unit. For example, the second SOC 204 may operate as a specialized 5G processing unit responsible for managing high volume, high speed (e.g., 5 Gbps, etc.), and/or very high frequency short wavelength (e.g., 28 GHz mmWave spectrum, etc.) communications.

The first SOC 202 may include a digital signal processor (DSP) 210, a modem processor 212, a graphics processor 214, an application processor 216, one or more coprocessors 218 (e.g., vector co-processor) connected to one or more of the processors, memory 220, custom circuity 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, the plurality of mm Wave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (e.g., FreeBSD, LINUX, OS X, etc.) and a processor that executes a second type of operating system (e.g., MICROSOFT WINDOWS 10). In addition, any or all of the processors 210, 212, 214, 216, 218, 252, 260 may be included as part of a processor cluster architecture (e.g., a synchronous processor cluster architecture, an asynchronous or heterogeneous processor cluster architecture, etc.).

The first and second SOC 202, 204 may include various system components, resources, and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a wireless device. The system components and resources 224 and/or custom circuitry 222 may also include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mm Wave transceivers 256, memory 258, and various additional processors 260 via the interconnection/bus module 264. The interconnection/bus module 226, 250, 264 may include an array of reconfigurable logic gates and/or implement a bus architecture (e.g., CoreConnect, AMBA, etc.). Communications may be provided by advanced interconnects, such as high-performance networks-on chip (NoCs).

The first and/or second SOCs 202, 204 may further include an input/output module (not illustrated) for communicating with resources external to the SOC, such as a clock 206 and a voltage regulator 208. Resources external to the SOC (e.g., clock 206, voltage regulator 208) may be shared by two or more of the internal SOC processors/cores.

In addition to the example SIP 200 discussed above, various embodiments may be implemented in a wide variety of computing systems, which may include a single processor, multiple processors, multicore processors, or any combination thereof.

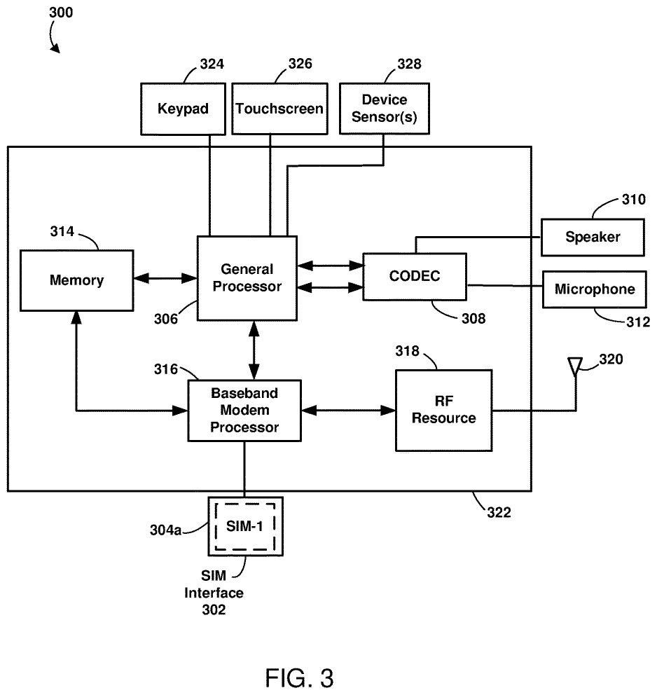

FIG. 3 is a functional block diagram of an example computing device 300 suitable for implementing various embodiments. With reference to FIGS. 1A-3, the computing device 300 may be similar to the computing device 100. For example, the computing device 300 may be a multi-SIM computing device, such as a multiple SIM multiple standby (MSMS) computing device. The computing device 300 may include at least one subscriber identity module (SIM) interface 302, which may receive a first SIM (“SIM-1”) 304a that is associated with a first subscription. In some embodiments, the at least one SIM interface 302 may be implemented as multiple SIM interfaces 302, which may receive at least a second that is associated with at least a second subscription.

A SIM in various embodiments may be a Universal Integrated Circuit Card (UICC) that is configured with SIM and/or universal SIM (USIM) applications, enabling access to a variety of different networks. The UICC may also provide storage for a phone book and other applications. Alternatively, in a code division multiple access (CDMA) network, a SIM may be a UICC removable user identity module (R-UIM) or a CDMA subscriber identity module (CSIM) on a card.

Each SIM 304a may have a CPU, ROM, RAM, EEPROM and I/O circuits. One or more of the first SIM 304a and any additional SIMs used in various embodiments may contain user account information, an international mobile station identifier (IMSI), a set of SIM application toolkit (SAT) commands and storage space for phone book contacts. One or more of the first SIM 304a and any additional SIMs may further store home identifiers (e.g., a System Identification Number (SID)/Network Identification Number (NID) pair, a Home PLMN (HPLMN) code, etc.) to indicate the SIM network operator provider. An Integrated Circuit Card Identity (ICCID) SIM serial number may be printed on one or more SIM 304a for identification. In some embodiments, additional SIMs may be provided for use on the computing device 300 through a virtual SIM (VSIM) application (not shown). For example, the VSIM application may implement remote SIMs on the computing device 300 by provisioning corresponding SIM profiles.

The computing device 300 may include at least one controller, such as a general-purpose processor 306, which may be coupled to a coder/decoder (CODEC) 308. The CODEC 308 may in turn be coupled to a speaker 310 and a microphone 312. The general-purpose processor 306 may also be coupled to at least one memory 314. The memory 314 may be a non-transitory tangible computer readable storage medium that stores processor-executable instructions. For example, the instructions may include routing communication data relating to a subscription though the transmit chain and receive chain of a corresponding baseband-RF resource chain. The memory 314 may store operating system (OS), as well as user application software and executable instructions. The general-purpose processor 306 and memory 314 may each be coupled to at least one baseband-modem processor 316. Each SIM 304a in the computing device 300 may be associated with a baseband-RF resource chain that includes at least one baseband-modem processor 316 and at least one radio frequency (RF) resource 318.

The RF resource 318 may include receiver and transmitter circuitry coupled to at least one antenna 320 and configured to perform transmit/receive functions for the wireless services associated with each SIM 304a of the computing device 300. The RF resource 318 may implement separate transmit and receive functionalities or may include a transceiver that combines transmitter and receiver functions. The RF resource 318 may be configured to support multiple radio access technologies/wireless networks that operate according to different wireless communication protocols. The RF resource 318 may include or provide connections to different sets of amplifiers, digital to analog converters, analog to digital converters, filters, voltage controlled oscillators, etc. Multiple antennas 320 and/or receive blocks may be coupled to the RF resource 318 to facilitate multimode communication with various combinations of antenna and receiver/transmitter frequencies and protocols (e.g., LTE, Wi-Fi, Bluetooth and/or the like).

The baseband-modem processor of a computing device 300 may be configured to execute software including at least one modem stack associated with at least one SIM. SIMs and associated modem stacks may be configured to support a variety of communication services that fulfill different user requirements. Further, a particular SIM may be provisioned with information to execute different signaling procedures for accessing a domain of the core network associated with these services and for handling data thereof.

In some embodiments, the general-purpose processor 306, memory 314, baseband-modem processor 316, and RF resource 318 may be included in a system-on-chip device 322. The SIMS 304a and their corresponding interface(s) 302 may be external to the system-on-chip device 322. Further, various input and output devices may be coupled to components of the system-on-chip device 322, such as interfaces or controllers. Example user input components suitable for use in the computing device 300 may include, but are not limited to, a keypad 324, a touchscreen 326 (e.g., display 120a, foldable display 120b).

In some embodiments, the general-purpose processor 306 may be coupled to one or more device sensors 328. The device sensor(s) 328 may provide an output that includes information about the environment around the computing device 300. For example, the computing device may include an ambient light sensor configured to sense and intensity of ambient light incident on the ambient light sensor, and to provide an output to the general-purpose processor 306 including information about the intensity of the ambient light.

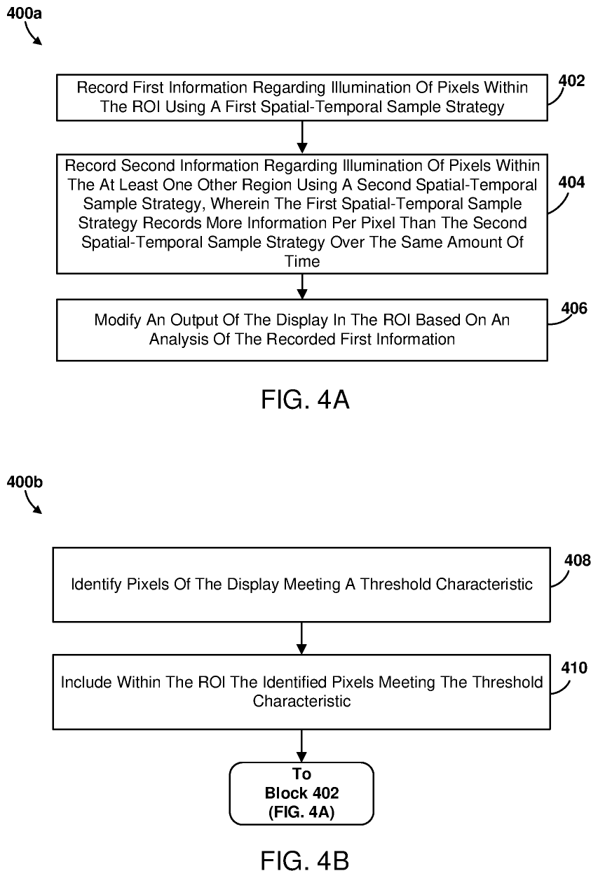

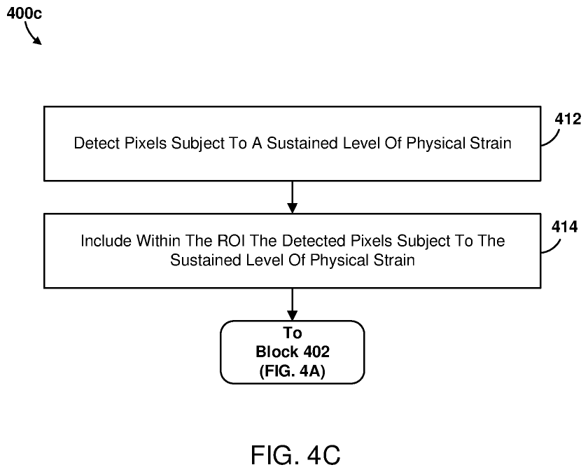

FIG. 4A is a process flow diagram illustrating a method 400a for controlling a computing device display performed by a processor of a computing device by modifying an output of an ROI of the display according to various embodiments. With reference to FIGS. 1A-4A, means for performing the operations of the method 400a may include a processor (e.g., 210, 212, 214, 216, 218, 252, 260, 306) of a computing device (e.g., 100a, 100b, 200, 300, 500) with memory (e.g., 220, 258, 314, 516) and a display device (e.g., 120a, 120b, 326) coupled to the processor. The processor may be any processor of the computing device configured to modify an output of select pixels of the display device. The display device may be any display that includes a ROI and at least one other region separate from the ROI.

In block 402, the processor may record first information regarding illumination of pixels within the ROI (e.g., 130a, 140b, 150b) using a first spatial-temporal sample strategy. For example, the processor may store, in memory, values associated with the pixels in the ROI, such as the supplied amount of electric current, the subpixel color intensities, the gray levels, the pixel refresh rate, and/or the pixel compensation. The ROI may be one or more regions of the display known or determined to be prone to aging faster than other regions of the display. For example, the ROI may correspond to a region of the display including a dynamic island, a folding region of a foldable display, and/or another region of the display other than a dynamic island or folding region of a foldable display.

In some aspects, the first spatial-temporal sample strategy for the first ROI may include a spatial dimension, such as a first number of pixels per sample (e.g., 1 physical sub-pixel sample per second) and the second spatial-temporal sample strategy for the at least one other region may include a different spatial dimension, such as a second number of pixels per sample (e.g., a group of pixels, such as a 4×4 or 8×8 tile of pixels sampled every minute). Additionally, or alternatively, the first spatial-temporal sample strategy for the first ROI may include a temporal dimension, such as a first sample rate (e.g., one sampling per second) and the second spatial-temporal sample strategy for the at least one other region may include a different temporal dimension, such as a second sample rate. The actual spatial-temporal sample strategy used as the first spatial-temporal sample strategy, the second spatial-temporal sample strategy, and/or any other spatial-temporal sample strategy may be based on at least one of memory or power consumption limits associated with sampling and available to the subject computing device.

In some aspects, the first information regarding illumination of pixels within the ROI may be recorded by the processor by recording the first information at a per-pixel level within the ROI. In some aspects, the first information regarding illumination of pixels within the ROI may be recorded by the processor by recording the first information at a sub-pixel level within the ROI.

In block 404, the processor may record second information regarding illumination of pixels within the at least one other region using a second spatial-temporal sample strategy, wherein the first spatial-temporal sample strategy records more information per pixel than the second spatial-temporal sample strategy over the same amount of time. For example, the processor may store, in memory, values associated with the pixels in the at least one other region, such as the supplied amount of electric current, the subpixel color intensities, the gray levels, the pixel refresh rate, and/or the pixel compensation. The at least one other region may be one or more regions of the display not known or determined to be prone to aging faster than other regions of the display. For example, the at least one other region may correspond to a main region of the display that does not include a dynamic island, a folding region of a foldable display, and/or another region of the display prone to premature aging.

In some aspects, the second information regarding illumination of pixels within the at least one other region may be recorded by the processor by recording pixel illumination information reflective of groups of pixels within the at least one other region, as compared to individual sub-pixels, individual pixels, or smaller groups of pixels within the ROI. Recording more information per pixel may enable a more refined and dynamic analysis of the pixels or sub-pixels in the ROI as compared to the at least one other region.

In block 406, the processor may modify an output of the display in the ROI based on an analysis of the recorded first information. Information regarding the illumination of pixels may be used to modify the display or portions of the display. Each pixel represents a single point of light on the display, and its information determines the color and intensity of that particular point. By modifying the pixel output, the overall image displayed on the screen can be altered. The pixel information may consist of color values and brightness levels. In most displays, each pixel is composed of three color components: red, green, and blue (RGB). The intensity values of these color components determine the final color of the pixel. For example, if the red component has a high intensity value while the green and blue components have low intensity values, the pixel will appear as a shade of red. To change (i.e., modify) the display, the pixel output can be altered in several ways resulting in modified pixel output. For example, pixel information may be modified by changing the color mapping, adjusting the brightness, transforming the image portrayed thus changing pixel output, and/or pixel output manipulation.

For example, the output of the display in the ROI may be modified by mapping the pixel information directly to different color values. This allows for changing the colors of individual pixels or applying various color effects to the entire image. For instance, increasing the intensity of the blue component while reducing the red and green components can give the image a bluish tint. As another example, by altering the intensity values of the RGB components, the overall brightness of each pixel can be adjusted. Increasing or decreasing the intensity uniformly across all pixels in the ROI may result in a brighter or darker image, respectively. As yet another example, advanced techniques can be applied to process the pixel information and apply various transformations. This may include operations like image resizing, rotation, cropping, filtering, or applying complex visual effects. Such operations can enhance the image, correct imperfections, or achieve specific artistic or technical objectives. As yet a further example, the pixel information can also be manipulated by display algorithms to improve visual quality. These algorithms may involve techniques such as anti-aliasing (smoothing jagged edges), dithering (creating new colors using patterns), or color space conversion (translating between different color representations).

Overall, the pixel information serves as the building block for generating the visual output on a display. By manipulating the color and brightness output of individual pixels, a processor may compensate for deterioration of pixels that would otherwise appear in images, videos, user interfaces, and other visual content within the ROI(s).

FIG. 4B is a process flow diagram illustrating operations 400b that may be performed by a processor of a computing device as part of the method 400a for modifying an output of an ROI of the display according to various embodiments. With reference to FIGS. 1A-4B, means for performing the operations 400b may include a processor (e.g., 210, 212, 214, 216, 218, 252, 260, 306) of a computing device (e.g., 100a, 100b, 200, 300) with memory (e.g., 220, 258, 314, 516) and a display device (e.g., 120a, 120b, 326) coupled to the processor.

In block 408, the processor may identify pixels of the display meeting a threshold characteristic. For example, the processor may perform a run-time analysis, such as using the run-time per frame or regional histogram and image segmentations recorded from the information regarding illumination of pixels to identify pixels meeting the threshold characteristic, which may reflect signs of premature aging. One threshold characteristic that may be used for this identification is the frequency and/or duration with which a pixel is filled with one fixed color, such as black. Extended frequencies and/or durations of being filled with one fixed color may make a pixel prone to premature aging. The pixels with the highest frequency of being filled with one fixed color may be identified as meeting the threshold characteristic, such as pixels filled with black more than a threshold percentage above the average or another target value. Alternatively, the identification of pixels meeting the threshold characteristic may be limited to regions frequently filled or expected to be filled for long durations with one fixed color, which regions may be designated for initial or further analysis. Every pixel on the display may be executed during a run-time to identify one or more ROIs. Alternatively, pixels in certain regions (e.g., the dynamic display region and/or the folding region of a foldable display) may be preemptively designated for analysis. In some embodiments, all regions of the display, except any preemptively designated regions, may be analyzed to identify pixels meeting the threshold characteristic. Once a pixel or region of pixels has been identified as meeting the threshold characteristic, that pixel or region of pixels may be added to the ROIs along with the preemptively and/or previously designated regions.

Some threshold characteristics that may be used to identify pixels in block 408 may include luminance degradation, color accuracy, brightness, and/or visible pixel defects. The length of time a pixel or sub-pixel is in the ON state may be used as an indicator that pixels need to be monitored more closely and thus included in the ROI. Thus, an accumulated on-time greater than a temporal threshold may be used as the threshold characteristic for identifying pixels to be included in the ROI, e.g., at least 100 hours, at least 200 hours, at least 300 hours, at least 400 hours, at least 500 hours, up to for example 2000 hours, up to 1500 hours, or up to 1000 hours, including any range using the foregoing as upper and/or lower limits, for example any range from about 100 hours to about 2000 hours.

OLEDs may experience a gradual decrease in brightness over time due to the organic materials' degradation. Luminance output below a threshold may reflect a pixel that is degraded enough to require the modification of its output, e.g., below 50 percent, below 60 percent, below 70 percent, below 80 percent, below 90 percent, or below about 95 percent.

Also, OLEDs are known for their excellent color reproduction. Color accuracy and consistency below a threshold may reflect a degraded pixel. For example, in graphic design the measure “Delta E” is used to refer to a measurement of how much a displayed color can differ from its input color, with a lower Delta E meaning better color accuracy. Various embodiments may use a color accuracy and consistency above a Delta E threshold, e.g., a Delta E greater than 3, greater than 4, greater than 5, greater than 6, greater than 7, greater than 8, greater than 9, greater than 10, greater than 11, etc. Delta E may be measured on a scale from 0 to 100, where 0 is less color difference, and 100 indicates complete distortion. For example, standard perception may range as follows: <=1.0: Not perceptible by the human eye; 1-2: Perceptible through close observation; 2-10: Perceptible at a glance; 11-49: Colors are more similar than the opposite; and 100: Colors are exactly the opposite.

In block 410, the processor may include within the ROI the identified pixels meeting the threshold characteristic. For example, the processor may originally define one or more ROIs in response to the identification in block 408. Alternatively, or additionally, the processor may add or subtract pixels from a previously defined ROI in response to the identification in block 408. As a further alternative or addition, the processor may include the identified pixels meeting the threshold characteristic to a new separate ROI.

Following the operations in block 410 the processor may record first information regarding illumination of pixels within the ROI using the first spatial-temporal sample strategy in block 402 as described above.

FIG. 4C is a process flow diagram illustrating operations 400c that may be performed by a processor of a computing device as part of the method 400a for modifying an output of an ROI of the display according to various embodiments. With reference to FIGS. 1A-4C, means for performing the operations 400c may include a processor (e.g., 210, 212, 214, 216, 218, 252, 260, 306) of a computing device (e.g., 100a, 100b, 200, 300) with memory (e.g., 220, 258, 314, 516) and a display device (e.g., 120a, 120b, 326) coupled to the processor.

In block 412, the processor may detect pixels subject to a sustained level of physical strain. For example, the processor may perform a run-time analysis, such as using the run-time per frame or regional histogram and image segmentations recorded from the information regarding illumination of pixels to identify pixels meeting the threshold characteristic to detect signs of premature aging. The threshold characteristic may be the same or similar to that described above with regard to block 408.

In block 414, the processor may include within the ROI the detected pixels subject to the sustained level of physical strain. For example, the processor may originally define one or more ROIs in response to the detection in block 412. Alternatively, or additionally, the processor may add or subtract pixels from a previously defined ROI in response to the detection in block 412. As a further alternative or addition, the processor may include the detected pixels to a new separate ROI.

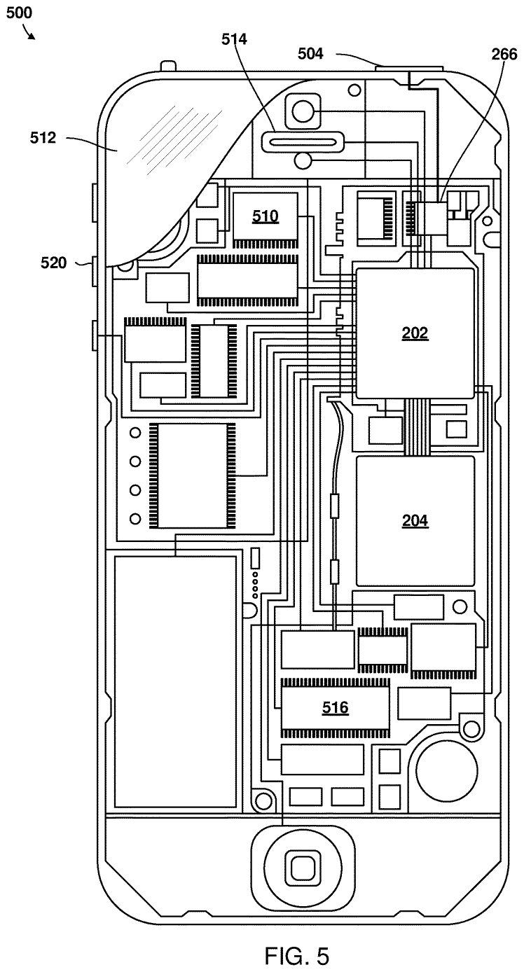

FIG. 5 is a component block diagram of a computing device 500 suitable for use with various embodiments. With reference to FIGS. 1A-5, the computing device 500 (e.g., 100a, 100b) may be configured to perform the operations of the methods and operations 400a-400c in various embodiments.

The computing device 500 may include a first SOC 202 (e.g., a SOC-CPU) coupled to a second SOC 204 (e.g., a 5G capable SOC). The first and second SOCs 202, 204 may be coupled to internal memory 516, a display 512, and to a speaker 514. Additionally, the computing device 500 may include an antenna 504 for sending and receiving electromagnetic radiation that may be connected to a wireless data link and/or cellular telephone transceiver 266 coupled to one or more processors in the first and/or second SOCs 202, 204. The computing device 500 may also include menu selection buttons or rocker switches 520 for receiving user inputs.

The computing device 500 also may include a sound encoding/decoding (CODEC) circuit 510, which digitizes sound received from a microphone into data packets suitable for wireless transmission and decodes received sound data packets to generate analog signals that are provided to the speaker to generate sound. Also, one or more of the processors in the first and second SOCs 202, 204, wireless transceiver 266 and CODEC may include a digital signal processor (DSP) circuit (not shown separately).

The processors of the computing device 500 may be any programmable microprocessor, microcomputer or multiple processor chip or chips that can be configured by software instructions (applications) to perform a variety of functions, including the functions of the various embodiments described below. In some mobile devices, multiple processors may be provided, such as one processor within an SOC 204 dedicated to wireless communication functions and one processor within an SOC 202 dedicated to running other applications.

Software applications may be stored in the memory 516 before they are accessed and loaded into the processor. The processors may include internal memory sufficient to store the application software instructions.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a wireless device and the wireless device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), 3GSM, general packet radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only and are not intended to limit the scope of the claims to a particular communication system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the methods and operations 400a-400c may be substituted for or combined with one or more operations of the methods and operations 400a-400c.

Implementation examples are described in the following paragraphs.

While some of the following implementation examples are described in terms of example systems and methods, further example implementations may include: the example operations discussed in the following paragraphs may be implemented by various computing devices for controlling a computing device display that includes an ROI and at least one other region separate from the ROI; the example methods discussed in the following paragraphs implemented by computing device including a processor configured with processor-executable instructions to perform operations of the methods of the following implementation examples; the example methods discussed in the following paragraphs implemented by computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.

Example 1. A method of modifying an output of a computing device display that includes an ROI and at least one other region separate from the ROI, the method including recording first information regarding illumination of pixels within the ROI using a first spatial-temporal sample strategy; recording second information regarding illumination of pixels within the at least one other region using a second spatial-temporal sample strategy, wherein the first spatial-temporal sample strategy records more information per pixel than the second spatial-temporal sample strategy over the same amount of time; and modifying an output of the display in the ROI based on an analysis of the recorded first information.

Example 2. The method of example 1, wherein the first spatial-temporal sample strategy includes a first number of pixels per sample and the second spatial-temporal sample strategy includes a second number of pixels per sample, wherein the first number of pixels per sample is less than the second number of pixels per sample.

Example 3. The method of any of examples 1-2, wherein the ROI corresponds to a region of the display including at least one of a dynamic island or a folding region of a foldable display.

Example 4. The method of any of examples 1-3, wherein the ROI corresponds to a region of the display other than a dynamic island or folding region of a foldable display.

Example 5. The method of any of examples 1-4, wherein recording the first information regarding illumination of pixels within the ROI includes recording the first information at a per-pixel level within the ROI.

Example 6. The method of any of examples 1-5, wherein recording the first information regarding illumination of pixels within the ROI includes recording the first information at a sub-pixel level within the ROI.

Example 7. The method of any of examples 1-6, wherein recording the second information regarding illumination of pixels within the at least one other region includes recording pixel illumination information reflective of groups of pixels within the at least one other region.

Example 8. The method of any of examples 1-7, further including: identifying pixels of the display meeting a threshold characteristic; and including within the ROI the identified pixels meeting the threshold characteristic.

Example 9. The method of example 8, wherein the threshold characteristic includes an accumulated on-time greater than a temporal threshold.

Example 10. The method of any of examples 1-9, further including detecting pixels subject to a sustained level of physical strain; and including within the ROI the detected pixels subject to the sustained level of physical strain.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular. In addition, reference to the term “and/or” should be understood to include both the conjunctive and the disjunctive. For example, “A and/or B” means “A and B” as well as “A or B.”

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality.

Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

1. A computing device, comprising:
a display that includes a region-of-interest (ROI) and at least one other region separate from the ROI; and
a processor coupled to the display, wherein the processor is configured to:
record first information regarding illumination of pixels within the ROI using a first spatial-temporal sample strategy;
record second information regarding illumination of pixels within the at least one other region using a second spatial-temporal sample strategy, wherein the first spatial-temporal sample strategy records more information per pixel than the second spatial-temporal sample strategy over the same amount of time; and
modify an output of the display in the ROI based on an analysis of the recorded first information.

2. The computing device of claim 1, wherein the processor is further configured such that the first spatial-temporal sample strategy includes a first number of pixels per sample and the second spatial-temporal sample strategy includes a second number of pixels per sample, wherein the first number of pixels per sample is less than the second number of pixels per sample.

3. The computing device of claim 1, wherein the ROI corresponds to a region of the display including at least one of a dynamic island or a folding region of a foldable display.

4. The computing device of claim 1, wherein the ROI corresponds to a region of the display other than a dynamic island or folding region of a foldable display.

5. The computing device of claim 1, wherein the processor is further configured to record the first information regarding illumination of pixels within the ROI by recording the first information at a per-pixel level within the ROI.

6. The computing device of claim 1, wherein the processor is further configured to record the first information regarding illumination of pixels within the ROI by recording the first information at a sub-pixel level within the ROI.

7. The computing device of claim 1, wherein the processor is further configured to record the second information regarding illumination of pixels within the at least one other region by recording pixel illumination information reflective of groups of pixels within the at least one other region.

8. The computing device of claim 1, wherein the processor is further configured to:
identify pixels meeting a threshold characteristic; and
include within the ROI the identified pixels meeting the threshold characteristic.

9. The computing device of claim 8, wherein the processor is further configured such that the threshold characteristic includes an accumulated on-time greater than a temporal threshold.

10. The computing device of claim 1, wherein the processor is further configured to:
detect pixels subject to a sustained level of physical strain; and
include within the ROI the detected pixels subject to the sustained level of physical strain.

11. A method of modifying an output of a computing device display including an ROI and at least one other region separate from the ROI, the method comprising:
recording first information regarding illumination of pixels within the ROI using a first spatial-temporal sample strategy;
recording second information regarding illumination of pixels within the at least one other region using a second spatial-temporal sample strategy, wherein the first spatial-temporal sample strategy records more information per pixel than the second spatial-temporal sample strategy over the same amount of time; and
modifying an output of the display in the ROI based on an analysis of the recorded first information.

12. The method of claim 11, wherein the first spatial-temporal sample strategy includes a first number of pixels per sample and the second spatial-temporal sample strategy includes a second number of pixels per sample, wherein the first number of pixels per sample is less than the second number of pixels per sample.

13. The method of claim 11, wherein the ROI corresponds to a region of the display including at least one of a dynamic island or a folding region of a foldable display.

14. The method of claim 11, wherein the ROI corresponds to a region of the display other than a dynamic island or folding region of a foldable display.

15. The method of claim 11, wherein recording the first information regarding illumination of pixels within the ROI includes recording the first information at a per-pixel level within the ROI.

16. The method of claim 11, wherein recording the first information regarding illumination of pixels within the ROI includes recording the first information at a sub-pixel level within the ROI.

17. The method of claim 11, wherein recording the second information regarding illumination of pixels within the at least one other region includes recording pixel illumination information reflective of groups of pixels within the at least one other region.

18. The method of claim 11, further comprising:
identifying pixels of the display meeting a threshold characteristic; and
including within the ROI the identified pixels meeting the threshold characteristic.

19. The method of claim 18, wherein the threshold characteristic includes an accumulated on-time greater than a temporal threshold.

20. The method of claim 11, further comprising:
detecting pixels subject to a sustained level of physical strain; and
including within the ROI the detected pixels subject to the sustained level of physical strain.

21-30. (canceled)
